(19) United States
(12) Patent Application Publication
(10) Pub. No.: US 2020/0158873 A1
(43) Pub. Date: May 21, 2020

(54) DISTANCE MEASURING APPARATUS AND CONTROL METHOD THEREFOR

(71) Applicant: VC INC., Seoul (KR)

(72) Inventors: Juno KIM, Anyang-si (KR); Hundong LIM, Yongin-si (KR); Sang II JIN, Seoul (KR)

(21) Appl. No.: 16/604,639

(22) PCT Filed: Apr. 17, 2018
(86) PCT No.: PCT/KR2018/004445

§ 371 Date: Oct. 11, 2019

(30) Foreign Application Priority Data
Jun. 12, 2017 (KR) 10-2017-0073164
Nov. 28, 2017 (KR) 10-2017-0159910

(51) Int. Cl. G01S 17/42; A63B 69/36; G01S 7/51

(52) U.S. Cl. CPC G01S 17/42; A63B 69/3691; G01S 7/51; A63B 2071/0691; A63B 2220/12; A63B 2225/50; A63B 2220/20

(57) ABSTRACT

Adistance measuring apparatus related to one exemplary embodiment includes: a display unit; a memory, in which map information about golf courses is stored; a location acquiring sensor configured to acquire a current location; an azimuth sensor configured to measure an azimuth; and a control unit configured to read map information of a golf course corresponding to the current location from the memory, and display a course map image, in which an object corresponding to the current location and a virtual line corresponding to the azimuth are displayed, on the display unit by using the map information.

### CROSS-REFERENCE TO RELATED APPLICATION

This application claims priority to and the benefit of Korean Patent Application No. 10-2017-0073164 filed in the Korean Intellectual Property Office on Jun. 12, 2017, and Korean Patent Application No. 10-2017-0159910 filed in the Korean Intellectual Property Office on Nov. 28, 2017, the entire contents of which are incorporated herein by reference.

### BACKGROUND

### (a) Field

The present disclosure relates to a distance measuring apparatus and a method for controlling the same.

### (b) Description of the Related Art

Golf is a sport, in which a golfer hits a golf ball into a hole. A golfer determines a target point in consideration of a current location of a golf ball and a location of a hole, and selects an appropriate golf club and hits the golf ball so that the golf ball moves to the target point.

First, in order to determine a location of a hole and a distance from a current location to the hole, a golfer refers to a flag (pin) affixed in a hole and a distance indication fixed facility installed along a fairway. Then, when the golfer recognizes a distance from the current location to the hole, the golfer determines a target point, to which the golfer will move the golf ball. However, the location of the hole is frequently changed, so that the fixed facility cannot reflect the momentarily changed location of the hole. Accordingly, it is difficult for the golfer to accurately recognize a distance from the current location to the hole, so that the target point may be a location, which is not appropriate for the golfer to hit the golf ball into the hole.

Further, even though an optical target point is determined, the golfer cannot accurately recognize a distance from the current location to the target point. Accordingly, a golf club, which the golfer selects in consideration of the distance from the current location to the target point, may be a golf club, which is not suitable to move the golf ball to the target point.

Recently, in order to more accurately measure a distance within a field, a distance measuring apparatus using a Global Positioning System (GPS) sensor, a distance measuring sensor, and the like, has been released. However, even though the distance measuring apparatus is used, it is difficult for a golfer to recognize a location of a target point within a field, and it is difficult to recognize whether a direction to the target point is appropriate. Further, when an obstacle obstructing a field of vision is present in front of the golfer, it is difficult for a golfer to measure a distance to a target point beyond the obstacle.

The above information disclosed in this Background section is only for enhancement of understanding of the background and therefore it may contain information that does not form the prior art that is already known in this country to a person of ordinary skill in the art.

### SUMMARY

An object of the present disclosure is to solve the foregoing problem and other problems. Another object of the present disclosure is to provide a distance measuring apparatus and a method for controlling the same, which displays a direction to a target point within a golf course.

Another object of the present disclosure is to provide a distance measuring apparatus and a method for controlling the same, which displays information on a target point within a golf course.

Another object of the present disclosure is to provide a distance measuring apparatus and a method for controlling the same, which displays information on a point of interest located in a target direction within a golf course.

According to an exemplary embodiment of the present invention for solving the objects, a distance measuring apparatus includes: a display unit; a memory, in which map information about golf courses is stored; a location acquiring sensor configured to acquire a current location; an azimuth sensor configured to measure an azimuth; and a control unit configured to read map information of a golf course corresponding to the current location from the memory, and display a course map image, in which an object corresponding to the current location and a virtual line corresponding to the azimuth are displayed, on the display unit by using the map information.

When the azimuth is changed, the control unit may change and display the virtual line on the course map in response to the changed azimuth.

The control unit may further display an indicator indicating a point of interest located in a direction corresponding to the azimuth on the course map by using the current location, the azimuth, and the map information.

The point of interest may include at least one of a hazard, a bunker, a rough, a green, and a hole located in the golf course.

The control unit may calculate a distance from the current location to the point of interest, and display a distance value to the point of interest on the display unit.

The distance from the current location to the point of interest may include at least one of a distance from the current location to a point, at which the point of interest starts and a distance from the current location to a point, at which the point of interest ends in a direction according to the azimuth.

The apparatus may further include: a distance measuring sensor configured to measure a distance to a target; and an acceleration sensor configured to measure a tilt angle, in which the control unit may calculate a horizontal distance value to the target by using a distance value to the target and the tilt angle, and display the horizontal distance value on the display unit.

The control unit may calculate location coordinates of the target by using the azimuth and the horizontal distance value and further display an object corresponding to the location coordinates of the target on the course map.

The control unit may further display a virtual line extended from an object corresponding to location coordinates of the target to one point on a green in the course map in the course map by using the location coordinates of the target.

The control unit may calculate a distance value from the target location to the one point on the green and display a distance value to the one point on the green on the display unit.

A method for controlling a distance measuring apparatus related to one exemplary embodiment includes: acquiring, by a location acquiring sensor, a current location of a distance measuring apparatus; reading, by a control unit, map information about a golf course corresponding to the current position from a memory, in which map information about golf courses is stored; measuring, by an azimuth sensor, an azimuth, toward the distance measuring apparatus heads; and displaying, by the control unit, a course map image, in which an object corresponding to the current location and a virtual line corresponding to the azimuth are displayed, on a display unit by using the map information.

The method may further include when the azimuth measured by the azimuth sensor is changed, changing and displaying, by the control unit, the virtual line on the course map in response to the changed azimuth.

The method may further include displaying, by the control unit, an indicator indicating a point of interest located in a direction corresponding to the azimuth on the course map by using the current location, the azimuth, and the map information.

The point of interest may include at least one of a hazard, a bunker, a rough, a green, and a hole located in the golf course.

The displaying of the indicator indicating the point of interest on the course map may include: calculating, by the control unit, a distance from the current location to the point of interest; and displaying, by the control unit, a distance value to the point of interest on the display unit.

The distance from the current location to the point of interest may include at least one of a distance from the current location to a point, at which the point of interest starts and a distance from the current location to a point, at which the point of interest ends in a direction according to the azimuth.

The method may further include: measuring, by a distance measuring sensor, a distance to a target; measuring, by an acceleration sensor, a tilt angle; calculating, by the control unit, a horizontal distance value to the target by using a distance value to the target and the tilt angle; and displaying, by the control unit, the horizontal distance value on the display unit.

The method may further include: calculating, by the control unit, location coordinates of the target by using the azimuth and the distance value; and displaying, by the control unit, an object corresponding to the location coordinates of the target in a course map.

The method may further include displaying, by the control unit, a virtual line extended from an object corresponding to location coordinates of the target to one point on a green in the course map in the course map by using the location coordinates of the target.

The method may further include: calculating, by the control unit, a distance from the target location to the one point on the green; and displaying the distance on the display unit.

The distance measuring apparatus and the method for controlling the same according to the present disclosure have the effects described below.

According to at least one of the exemplary embodiments of the present disclosure, there is an advantage in that a golfer is capable of easily checking information, such as directions, locations, and distances of a target point and a point of interest.

According to at least one of the exemplary embodiments of the present disclosure, there is an advantage in that a golfer is capable of checking information about a target point and a point of interest even in a situation where the golfer cannot check the target point with the eyes.

An additional range of the applicability of the present disclosure will be apparent based on the detailed description below. However, various changes and corrections within the range of the present disclosure may be clearly understood by those skilled in the art, and the detailed description and a specific exemplary embodiment, such as an exemplary embodiment of the present disclosure, shall be simply understood as an example.

### BRIEF DESCRIPTION OF THE DRAWINGS

FIG. 1 is a block diagram for describing a distance measuring apparatus related to one exemplary embodiment.

FIGS. 2 and 3 are conceptual diagrams of one example of the distance measuring apparatus related to one exemplary embodiment viewed in different directions.

FIG. 4 is a schematic structural diagram of an optical unit and a distance measuring sensor of the distance measuring apparatus related to one exemplary embodiment.

FIG. 5 is a flowchart of a method for controlling a distance measuring apparatus related to a first exemplary embodiment.

FIGS. 6 and 7 are diagrams illustrating images displayed on a display unit of the distance measuring apparatus according to the method for controlling FIG. 5.

FIG. 8 is a flowchart of a method for controlling a distance measuring apparatus related to a second exemplary embodiment.

FIG. 9 is a diagram illustrating an image displayed on a display unit of the distance measuring apparatus according to the method of FIG. 8.

FIG. 10 is a flowchart of a method for controlling a distance measuring apparatus related to a third exemplary embodiment.

FIG. 11 is a diagram illustrating an image displayed on a display unit of the distance measuring apparatus according to the method of FIG. 10.

FIG. 12 is a diagram illustrating an image displayed on a display unit according to the methods of the exemplary embodiments.

### DETAILED DESCRIPTION OF THE EMBODIMENTS

Hereinafter, an exemplary embodiment disclosed in the present specification will be described in detail with reference to the accompanying drawings, and the same or similar elements will be designated by the same or similar reference numerals, and the overlapping description thereof will be omitted. Suffixes, “module” and “unit” for a constituent element used for the description below are given or mixed in consideration of only easiness of the writing of the specification, and the suffix itself does not have a discriminated meaning or role. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

It should be understood that when one constituent element is referred to as being “coupled to” or “connected to” another constituent element, one constituent element can be directly coupled to or connected to the other constituent element, but intervening elements may also be present. In contrast, when one constituent element is “directly coupled to” or “directly connected to” another constituent element, it should be understood that there are no intervening element present.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

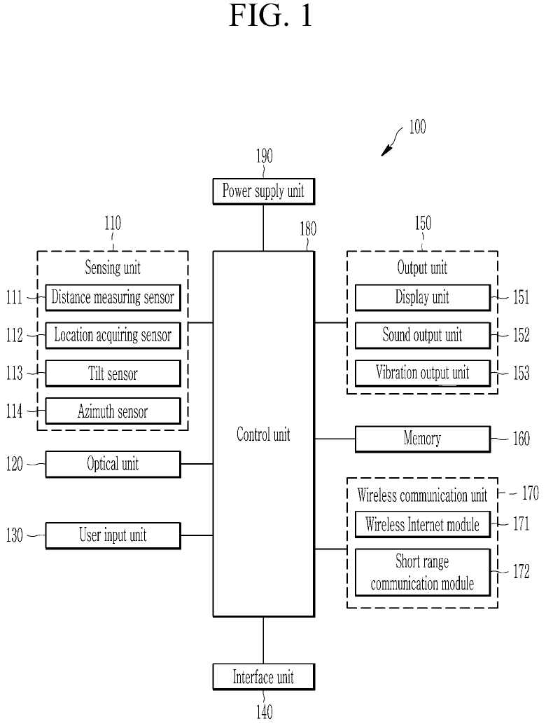

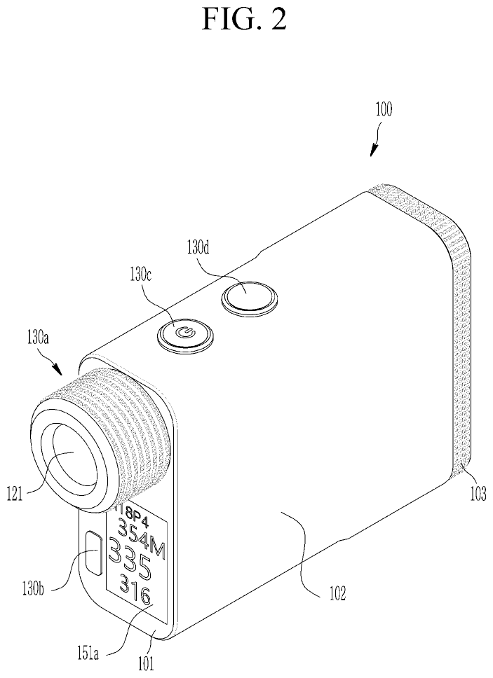

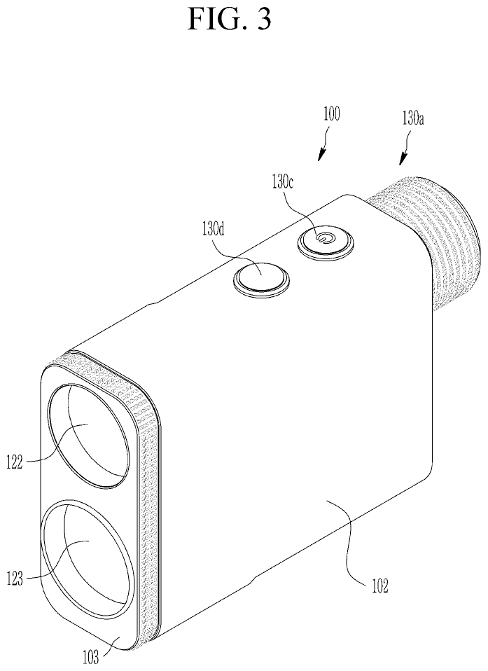

FIG. 1 is a block diagram for describing a distance measuring apparatus 100 related to one exemplary embodiment, and FIGS. 2 and 3 are conceptual diagrams of one example of the distance measuring apparatus 100 related to one exemplary embodiment viewed in different directions.

The distance measuring apparatus 100 may include a sensing unit 110, an optical unit 120, a user input unit 130, an interface unit 140, an output unit 150, a memory 160, a wireless communication unit 170, a control unit 180, a power supply unit 190, and the like. The constituent elements shown in FIG. 1 are not essential for implementing the distance measuring apparatus 100, so that the distance measuring apparatus 100 described in the present specification may include more or less constituent elements than the foregoing listed constituent elements.

More particularly, among the constituent elements, the sensing unit 11 may include one or more sensors for sensing at least one of information on a surrounding environment surrounding the distance measuring apparatus 100 and information within the distance measuring apparatus 100. For example, the sensing unit 110 may include at least one of a distance measuring sensor 111, a location acquiring sensor 112, an acceleration sensor 113, an azimuth sensor 114, a gyroscope sensor, a battery gauge, and an environment sensor (for example, a barometer, a hydrometer, and a thermometer). In the meantime, the distance measuring apparatus 100 disclosed in the present specification may utilize a combination of information sensed by at least two or more sensors among the sensors.

First, the distance measuring sensor 111 refers to a sensor which measures a distance to a target. The distance measuring sensor 111 may include an ultrasonic sensor, an infrared sensor (IR sensor), a laser sensor, a radio detecting and ranging sensor (Radar sensor), an optical sensor (for example, a camera), and the like. The distance measuring sensor 111 is not limited to the listed kinds of sensors, and includes all of the kinds of sensor measuring a distance to a target.

Hereinafter, it is assumed that the distance measuring sensor 111 is a laser sensor, which transmits a laser in a front direction, and receives a laser reflected from a target to measure a distance to a target.

The location acquiring sensor 112 is a sensor for acquiring a location of the distance measuring apparatus 100, and a representative example of the location acquiring sensor 112 is a global positioning system (GPS) sensor. The GPS sensor calculates distance information separated from three or more satellites and accurate time information and then applies trigonometry to the calculated information, thereby accurately calculating 3D current location information according to the latitude, the longitude, and the altitude. Currently, a method of calculating location and time information by using three satellites and correcting errors of the calculated location and time information by using another one satellite is widely used. Further, the GPS sensor may calculate speed information by continuously calculating a current location in real time.

The slope sensor 113 may acquire the degree of tilt of the distance measuring apparatus 100. The slope sensor 113 may include an acceleration sensor (accelerometer) measuring an acceleration of gravity. Further, the slope sensor 113 may also be implemented by a scheme of calculating a tilt by using a rotation angle in a vertical direction from a predetermined reference direction acquired by a gyro sensor, and the like.

The azimuth sensor 114 is a sensor measuring an azimuth, and may acquire a value of an azimuth, at which the distance measuring apparatus 100 heads. The azimuth sensor 114 may be a geomagnetic sensor, which detects an earth's magnetic field and measures an azimuth. Further, the azimuth sensor 114 may also be implemented by a scheme of calculating an azimuth by using a rotation angle in a horizontal direction from a predetermined reference direction acquired by a gyro sensor, and the like.

The optical unit 120 has a structure for receiving external light, and may include a lens unit, a filter unit, and the like. The optical unit 120 optically processes light from a subject.

The lens unit may include a zoom lens, a focus lens, a compensate lens, and the like, and the filter unit may include an ultraviolet filter (UV filter), an optical low pass filter, and the like.

Next, the user input unit 130 receives an input of information from a user, and when information is input through the user input unit 130, the control unit 180 may control an operation of the distance measuring apparatus 100 so as to correspond to the input information. The user input unit 130 may include a mechanical input means (for example, a mechanical key, for example, a button located on a front surface, a rear surface, or a lateral surface of the distance measuring apparatus 100, a dome switch, a jog wheel, and a jog switch) and a touch-type input means. For example, the touch-type input means may be formed of a virtual key, a soft key, or a visual key displayed on a touch screen through software processing, or a touch key disposed in a portion other than the touch screen. In the meantime, the virtual key or the visual key may be displayed on the touch screen with various forms, and for example, the virtual key or the visual key may be formed of a graphic, a text, an icon, a video, or a combination thereof.

The interface unit 140 serves as a passage of various kinds of external device connected with the distance measuring apparatus 100. The interface unit 140 may include at least one of an external charger port, a wired/wireless data port, and a memory 160 card port. The distance measuring apparatus 100 may perform an appropriate control related to the connected external device in response to the connection of the external device to the interface unit 140.

The output unit 1450 generates an output related to a visual sense, an auditory sense, or a tactile sense, and may include a display unit 151, a sound output unit 152, a vibration output unit 153, and the like.

The display unit 151 displays (outputs) information processed by the distance measuring apparatus 100. For example, the display unit 151 may display execution image information of an application program driven in the distance measuring apparatus 100, or user interface (UI) and graphic user interface (GUI) information according to the execution image information.

The display unit 151 may include at least one of a liquid crystal display (LCD), a thin film transistor-liquid crystal display (TFT LCD), an organic light-emitting diode (OLED), and an e-ink display.

Further, two or more display units 151 may be present according to the form of implementation of the distance measuring apparatus 100. In this case, the plurality of display units 151 may be disposed together on an external surface of the distance measuring apparatus 100 and in an internal portion of the distance measuring apparatus 100, or the plurality of display units 151 may be individually disposed on an external surface of the distance measuring apparatus 100 and in an internal portion of the distance measuring apparatus 100, respectively.

The display unit 151a disposed on the external surface of the distance measuring apparatus 100 may include a touch sensor, which detects a touch to the display unit 151a, so as to receive an input of a control command by a touch scheme. When a touch is input to the display unit 151a by using the display unit 151a, the touch sensor may detect the touch, and the control unit 180 may generate a control command corresponding to the touch based on the detected touch. Contents input by the touch scheme may be letters or numbers, or may be menu items indicatable or designable in various modes.

The display unit 151b disposed in the internal portion of the distance measuring apparatus 100 may display an image to a user through an ocular 121 of the distance measuring apparatus 100. The display unit 151b disposed in the internal portion of the distance measuring apparatus 100 includes a transparent display (or a semi-transparent display), which is directly located on an optical path of the ocular 121. A representative example of the transparent display is a transparent OLED (TOLED). Further, the display unit 151b disposed in the internal portion of the distance measuring apparatus 100 may be an opaque display, which provides an image to the optical path of the ocular 121 through an optical member having a function of refracting or reflecting light and the like.

The sound output unit 152 may output audio data stored in the memory 160 in the form of a sound, and may be implemented in the form of a loud speaker, which outputs various alarm sounds or a playback sound of multimedia.

The vibration output unit 153 generates various tactile effects which the user may feel. An intensity, a pattern, and the like of the vibration generated by the vibration output unit 153 may be controlled by a selection of the user or a setting of the control unit 180. For example, the vibration output unit 153 may also combine and output different vibrations or sequentially output different vibrations.

In addition, the output unit 150 may also further include a light output unit, which outputs a signal notifying a generation of an event by using light of a light source.

Further, the memory 160 stores data (for example, the data includes course map information about a tee box, a fairway, a hazard, a bunker, a rough, a green, and a hole of a golf course, and the like, but is not limited thereto) supporting various functions of the distance measuring apparatus 100. The memory 160 may store firmware and an application program driven in the distance measuring apparatus 100 and data and commands for an operation of the distance measuring apparatus 100. At least a part of the application programs may be installed in the distance measuring apparatus 100 at the time of the release for a basic function of the distance measuring apparatus 100. Further, at least a part of the application programs may be downloaded from an external server through wireless communication. In the meantime, the application program may be stored in the memory 160 and is installed in the distance measuring apparatus 100, thereby being driven so as to perform the operation (or the function) of the distance measuring apparatus 100 by the control unit 180.

The wireless communication unit 170 may include one or more modules, which are capable of establishing wireless communication between the distance measuring apparatus 100 and a wireless communication system, the distance measuring apparatus 100 and other wireless communication available devices, or the distance measuring apparatus 100 and an external server.

The wireless communication unit 170 may include a wireless Internet module 171 and a short range communication module 172.

The wireless Internet module 171 refers to a module for a wireless Internet connection, and may be embedded in the distance measuring apparatus 100. The wireless Internet module 171 transceives a wireless signal in a communication network according to the wireless Internet technologies. Examples of the wireless Internet technology include a Wireless Local Area Network (WLAN), Wireless Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A), and the wireless Internet module 171 transceives data according to at least one wireless Internet technology in a range including the Internet technology, which is not listed above.

The short range communication module 172 is for short range communication, and may support short range communication by using at least one of Bluetooth™, Radio Frequency Identification (RFID), Infrared Data Association (IrDA), Ultra Wideband (UWB), ZigBee, Near Field Communication (NFC), Wi-Fi, Wi-Fi direct, Wireless Universal Serial Bus (USB) technologies. The short range communication module 172 may support wireless communication between the distance measuring apparatus 100 and a wireless communication system, the distance measuring apparatus 100 and a wireless communication available device, or the distance measuring apparatus 100 and a network, in which an external server is located, through a wireless area network. The wireless area network may be a wireless personal area network.

Herein, the wireless communication available device may be a wearable device (for example, a smart watch and smart glasses) which is capable of exchanging (interlocking) data with the distance measuring apparatus 100 according to the present invention. The short range communication module 172 may detect (or recognize) a wearable device, which is capable of communicating with the distance measuring apparatus 100, around the distance measuring apparatus 100. Further, when the detected wearable device is a device authenticated to communicate with the distance measuring apparatus 100 according to the exemplary embodiment, the control unit 180 may transmit at least a part of the data processed in the distance measuring apparatus 100 to the wearable device through the short range communication module 172. Accordingly, a user of the wearable device may use the data processed in the distance measuring apparatus 100 through the wearable device.

The control unit 180 generally controls a general operation of the distance measuring apparatus 100 in addition to the operation related to the application program. The control unit 180 processes the input or output signal, data, information, and the like or drive the application program stored in the memory 160 through the foregoing constituent elements, thereby providing the user with or processing the appropriate information or function.

Further, the control unit 180 may control at least a part of the constituent elements described with reference to FIG. 1 in order to drive the application program stored in the memory 160. Further, the control unit 180 may combine two or more of the constituent elements included in the distance measuring apparatus 100 and operate the combined constituent elements for driving the application program.

The power supply unit 190 receives an external power source and an internal power source and supplies the power source to each constituent elements included in the distance measuring apparatus 100 under the control of the control unit 180. The power supply unit 190 includes a battery, and the battery may be an embedded battery or a replaceable battery.

At least a part of the constituent elements may cooperate with each other and be operated for operating, controlling, or implementing a method for controlling the distance measuring apparatus 100 according to various exemplary embodiments described below. Further, the operation, the control, or the method for controlling the distance measuring apparatus 100 may be implemented in the distance measuring apparatus 100 through the driving of at least one application program stored in the memory 160.

Referring to FIGS. 2 and 3, the disclosed distance measuring apparatus 100 includes a body having the form of a column, of which a front surface and a rear surface are oval track shapes. However, the present invention is not limited thereto, and is applicable to various structures, such as a watch type, a clip type, a glasses type, or a slide type, a swing type, and a swivel type, in which two or more bodies are combined to be relatively movable. The form of the body may be related to a specific type of the distance measuring apparatus 100, but a description of the specific type of the distance measuring apparatus 100 may be generally applied to the distance measuring apparatus 100 in other types.

Herein, the body may be understood as a concept referring to that the distance measuring apparatus 100 is considered as at least one assembly.

The distance measuring apparatus 100 includes a case (for example, a frame, a housing, and a cover) configuring an exterior appearance. As shown, the distance measuring apparatus 100 may include a front case 101, a middle case 102, and a rear case 103. Various electronic components are disposed in an internal space formed by a combination of the front case 101, the middle case 102, and the rear case 103.

The cases may be formed by injecting a synthetic resin or may be formed of a metal, for example, stainless steel (STS), aluminum (Al), and titanium (Ti), and external portions of the cases may also be covered with leather, rubber, and the like.

An ocular lens 121, a first operation unit 130a, a second operation unit 130b, and a display unit 151a may be disposed in the front case 101. In this case, the first operation unit 130a may be disposed in the form of a jog wheel in a circumference of the ocular lens 121, thereby protecting the ocular lens 121.

A third operation unit 130c and a fourth operation unit 130d may be disposed on one surface of the middle case 102. The user may conveniently operate the third operation unit 130c and the fourth operation unit 130d while holding the distance measuring apparatus 100.

One or more object lens 122 and 123 may be disposed in the rear case 103. The object lens 122 and 123 may receive light from the outside. For example, the object lens 122 located at the upper side may receive light from a subject to enable the user to check the subject with eyes through the ocular lens 121. When the laser emitted from the distance measuring apparatus 100 is reflected from the target, the object lens 123 located at the lower side may receive the reflected laser.

The configurations are not limited to the foregoing disposition. The configurations may be excluded or replaced as necessary, or may be disposed in other surfaces. For example, the display unit 151a and the second operation unit 130b may not be provided in the front surface of the body, and the number of operation units 130a, 130b, 130c, and 130d may be changed.

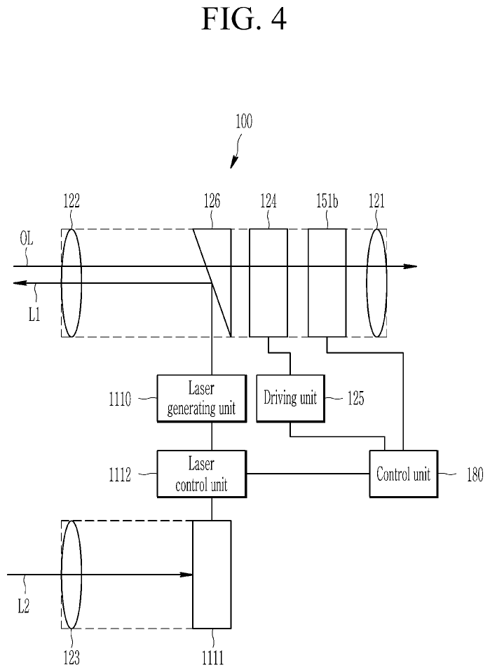

Next, the optical unit 120 and the distance measuring sensor 111 of the distance measuring apparatus 100 will be described in detail with reference to FIG. 4.

FIG. 4 is a schematic structural diagram of the optical unit 120 and the distance measuring sensor 111 of the distance measuring apparatus 100 related to one exemplary embodiment.

The distance measuring apparatus 100 according to one exemplary embodiment includes the two object lens 122 and 123, one ocular lens 121, a light path changing unit 126, a light processing unit 124, the display unit 151a, a laser generating unit 1110, a laser receiving unit 1111, a laser control unit 1112, and the control unit 180.

Through the first object lens 122, external light OL may be incident to the distance measuring apparatus 100 or a laser L1 generated in the laser generating unit 1110 may be emitted to the outside. A path of the laser L1 generated in the laser generating unit 1110 may be changed through the light path changing unit 126 so that the laser L1 heads the first object lens 122.

The external light OL passes through the first object lens 122 and the light path changing unit 126 to be incident to the light processing unit 124. The light processing unit 124 includes a lens unit and a filter unit. The external light OL incident to the light processing unit 124 is optically processed and heads the ocular lens 121 side. The lens unit processes light according to the driving of the driving unit 125. For example, when the user operates the first operation unit 130a and the like, the driving unit 125 is driven and a zoom lens moves, so that a zoom-in or zoom-out operation is performed.

Through the second object lens 123, a laser L2 reflected from the target may be incident to the distance measuring apparatus 100. The laser receiving unit 1111 receives the laser L2 incident through the second object lens 123, and outputs a corresponding signal to the laser control unit 1112.

Then, the laser control unit 1112 may calculate a distance from the distance measuring apparatus 100 to the target by using the signal received from the laser receiving unit 1111. The calculated distance value is output to the control unit 180.

The display unit 151b may be formed of a transparent or semi-transparent display and be directly disposed in a path, through which the external light OL passes. Otherwise, the display unit 151b may provide an image to the optical path of the ocular lens 121 through an optical member having a function of refracting or reflecting light and the like.

Hereinafter, a control method implementable by the distance measuring apparatus 100 formed as described above and relevant exemplary embodiments will be described with reference to the accompanying drawings. It is obvious to those skilled in the art that the present invention may be embodied to another specific form within a range of a spirit and an essential characteristic of the present invention.

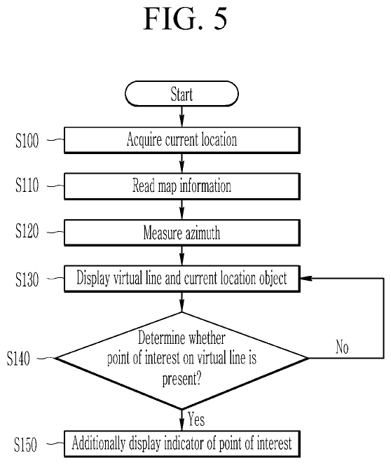

A method for controlling the distance measuring apparatus 100 related to a first exemplary embodiment will be described with reference to FIGS. 5 to 7.

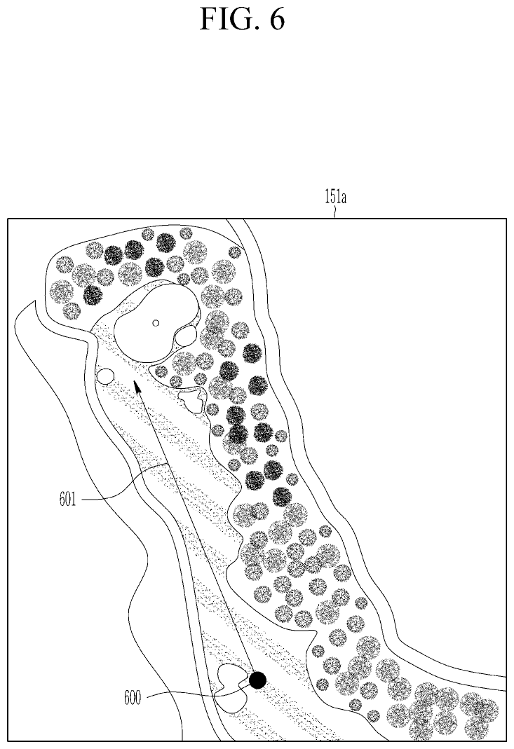

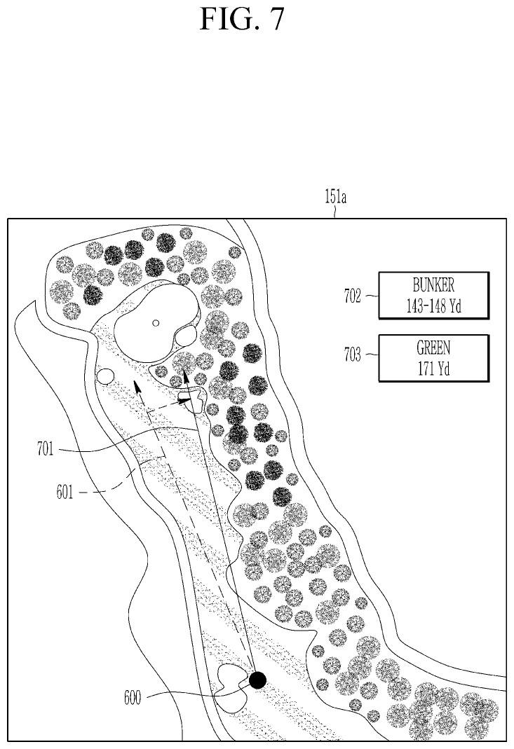

FIG. 5 is a flowchart of a method for controlling the distance measuring apparatus 100 related to the first exemplary embodiment, and FIGS. 6 and 7 are diagrams illustrating images displayed on the display unit 151a of the distance measuring apparatus 100 according to the method of FIG. 5.

First, the location acquiring sensor 112 acquires a current location (S100). The location acquiring sensor 112 may acquire coordinates of a current location of the distance measuring apparatus 100.

The control unit 180 reads course map information corresponding to the coordinates of the current location from the memory 160 (5110). The course map information may include map image information about a course, scale information about a map image, location coordinate information corresponding to reference points of the map image, and the like.

The control unit 180 may determine a course including the current location by using location coordinate information corresponding to reference points (for example, the reference points include four corners of the quadrangular map image, but are not limited thereto) of the map image of the course map information.

The azimuth sensor 114 measures an azimuth in a heading direction of the distance measuring apparatus 100 (S120).

Then, as shown in FIG. 6, the control unit 180 displays a course map image, in which an object 600 corresponding to the current location and a virtual line 601 corresponding to the heading direction of the distance measuring apparatus 100 are displayed, on the display unit 151a (S130).

The control unit 180 may determine a location of the object corresponding to the current location coordinates within the map image by using the current location coordinates, the location coordinate information corresponding to the reference points, and the scale information of the map image.

When the coordinates of the current location measured by the location acquiring sensor 112 are changed, the control unit 180 moves and displays the object 600 on the course map corresponding to the changed coordinates. When the azimuth measured by the azimuth sensor 114 is changed, the control unit 180 changes and displays the virtual line 701 on the course map corresponding to the changed azimuth as shown in FIG. 7.

Further, the control unit 180 determines whether a point of interest, such as a hazard, a bunker, a rough, a green, and a hole, is located in the heading direction of the distance measuring apparatus 100 (S140).

When the point of interest, such as a hazard, a bunker, a rough, a green, and a hole, is located in the heading direction of the distance measuring apparatus 100, the control unit 180 additionally displays indicators 702 and 703 indicating the points of interest on the course map (S150). In this case, the control unit 180 may additionally display a distance from a current point to the point of interest (for example, a distance from the current location to a point, at which the hazard, the bunker, or the green starts in the heading direction of the distance measuring apparatus 100, and a distance from the current location to a point, at which the hazard, the bunker, or the green ends in the heading direction of the distance measuring apparatus 100).

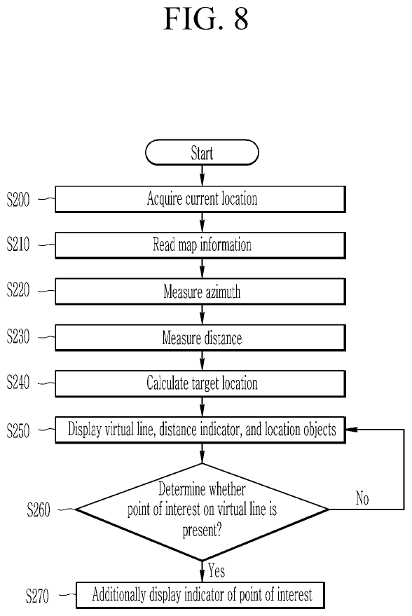

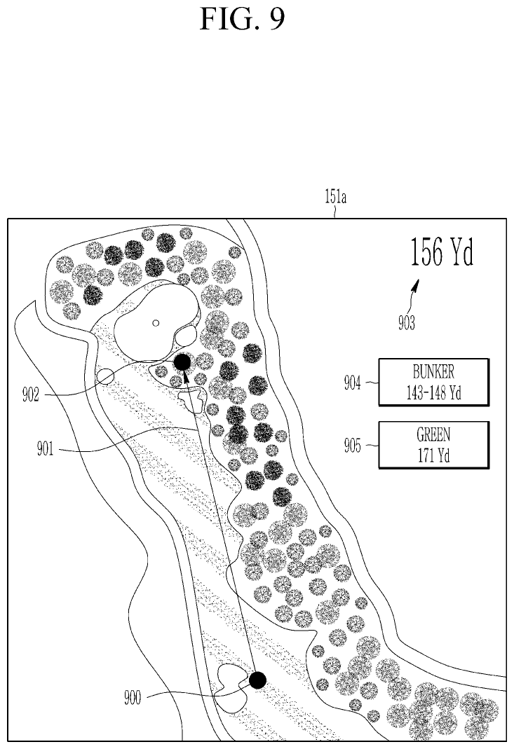

Next, a method for controlling the distance measuring apparatus 100 related to a second exemplary embodiment will be described with reference to FIGS. 8 to 9.

FIG. 8 is a flowchart of a method for controlling the distance measuring apparatus 100 related to the second exemplary embodiment, and FIG. 9 is a diagram illustrating an image displayed on the display unit 151a of the distance measuring apparatus 100 according to the method of FIG. 8.

First, the location acquiring sensor 112 acquires a current location (S200). The location acquiring sensor 112 may acquire coordinates of a current location of the distance measuring apparatus 100.

The control unit 180 reads course map information corresponding to the coordinates of the current location from the memory 160 (S210).

The azimuth sensor 114 measures an azimuth in a heading direction of the distance measuring apparatus 100 (S220).

The control unit 180 calculates a distance from the distance measuring apparatus 100 to a target by using the distance measuring sensor 111 and the acceleration sensor 113. For example, the distance measuring sensor 111 measures a straight distance from the distance measuring apparatus 100 to the target, and the acceleration sensor 113 measures an angle of a tilt (hereinafter, referred to as a “tilt angle”) of the distance measuring apparatus 100 to the target. Then, the control unit 180 calculates a horizontal distance from the distance measuring apparatus 100 to the target according to Equation 1 by using the measured straight distance and tilt angle.

L=D×cos TA (Equation 1)

In Equation 1, L is a horizontal distance from the distance measuring apparatus 100 to the target, D is a straight distance measured by the distance measuring sensor 111, and TA is a tilt angle.

Then, the control unit 180 calculates location coordinates of the target by using the measured azimuth and distance (S240).

As shown in FIG. 9, the control unit 180 displays a course map image, in which an object 900 corresponding to the current location, an object 902 corresponding to the target location, and a virtual line 901 corresponding to the heading direction of the distance measuring apparatus 100 are displayed, on the display unit 151a (S250). In this case, a length of the virtual line 901 corresponds to a distance to the target.

Further, the control unit 180 may also display a distance 903 to the target on the display unit 151a.

The control unit 180 determines whether a point of interest, such as a hazard, a bunker, a rough, and a green, is located in the heading direction of the distance measuring apparatus 100 (S260).

When the point of interest, such as the hazard, the bunker, the rough, and the green, is located in the heading direction of the distance measuring apparatus 100, the control unit 180 additionally displays indicators 904 and 905 indicating the points of interest on the course map (S270). In this case, the control unit 180 may additionally display a distance from a current point to the point of interest.

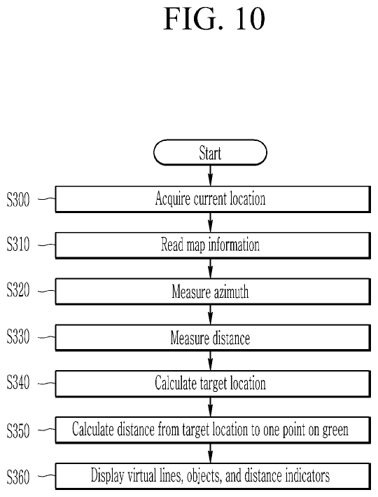

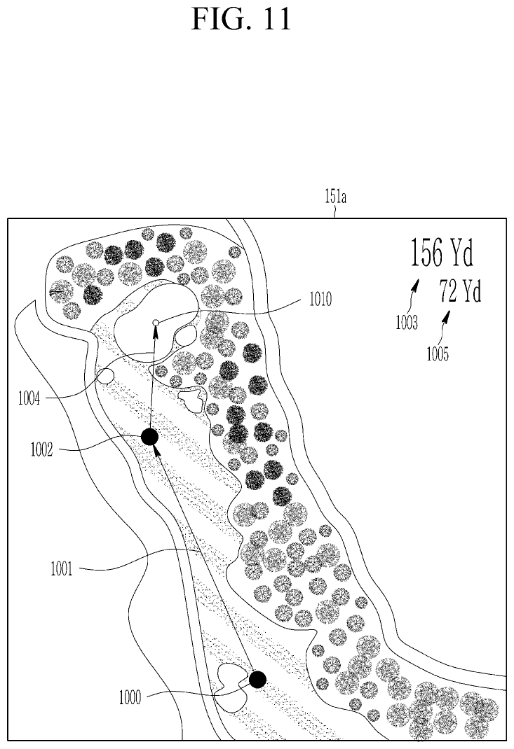

Next, a method for controlling the distance measuring apparatus 100 related to a third exemplary embodiment will be described with reference to FIGS. 10 and 11.

FIG. 10 is a flowchart of a method for controlling the distance measuring apparatus 100 related to the third exemplary embodiment, and FIG. 11 is a diagram illustrating an image displayed on the display unit 151a of the distance measuring apparatus 100 according to the method for controlling FIG. 10.

First, the location acquiring sensor 112 acquires a current location (S300). The location acquiring sensor 112 may acquire coordinates of a current location of the distance measuring apparatus 100.

The control unit 180 reads course map information corresponding to the coordinates of the current location from the memory 160 (S310).

The azimuth sensor 114 measures an azimuth in a heading direction of the distance measuring apparatus 100 (S320).

The control unit 180 calculates a distance from the distance measuring apparatus 100 to a target by using the distance measuring sensor 111 and the acceleration sensor 113 (S330).

Then, the control unit 180 calculates location coordinates of the target by using the measured azimuth and distance (S340).

When the location coordinates of the target are completely calculated, the control unit 180 calculates a distance from a target location 1002 to one point 1010 on a green (S350). The coordinates of one point 1010 on the green may be at least one of location coordinates of a hole of a course map information stored in the memory 160, location coordinates of a specific point within a green selected by a user, and location coordinates of a hole of a course map information downloaded from an external server. Further, one point on the green may also be any one point within the green or any one point in a boundary of the green, but is not limited thereto.

As shown in FIG. 11, the control unit 180 displays a course map image, in which an object 1000 corresponding to the current location, an object 1002 corresponding to the target location, a first virtual line 1001 corresponding to the heading direction of the distance measuring apparatus 100, and a second virtual line 1004 indicating a path from the target location to one point 1010 on the green are displayed, on the display unit 151a (S360). In this case, a length of the first virtual line 1001 corresponds to a distance from the current location to the target, and a length of the second virtual line 1004 corresponds to a distance from the location of the target to one point 1010 on the green.

Further, the control unit 180 displays an indicator 1003 representing a distance value from the current location to the target location and an indicator 1005 representing a distance value from the target location to one point on the green on the display unit 151a.

According to the distance measuring apparatus 100 and the control method 100 of the distance measuring apparatus 100 described above, there is an advantage in that a user is capable of easily checking information, such as directions, locations, and distances of a target point and a point of interest.

Further, according to the distance measuring apparatus 100 and the control method 100 of the distance measuring apparatus 100 described above, there is an advantage in that a user is capable of checking information about a target point and a point of interest even in a situation where the user cannot check the target point with the eyes.

Further, according to the distance measuring apparatus 100 and the control method 100 of the distance measuring apparatus 100 described above, there is an advantage in that a user is capable of checking information about one point on a green even in a situation where the user cannot check the one point on the green with the eyes.

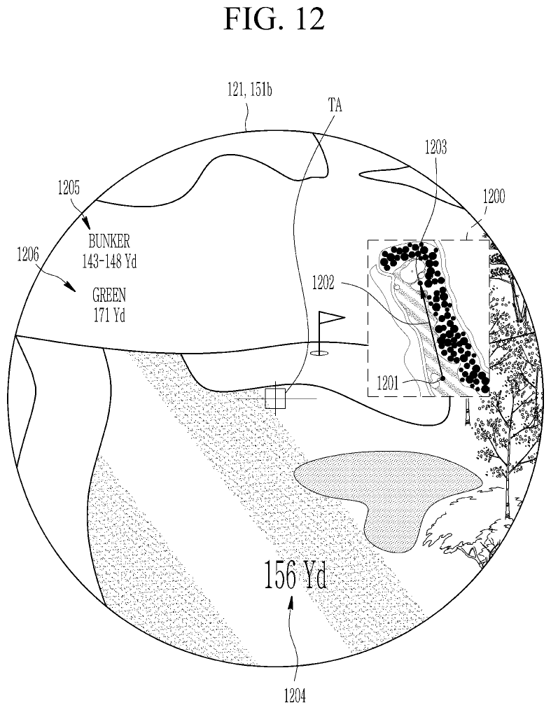

Next, an image provided by a display unit 151b located inside the distance measuring apparatus 100 will be described with reference to FIG. 12.

FIG. 12 is a diagram illustrating an image displayed on a display unit 151b according to the control methods of the exemplary embodiments.

A user may view an external subject through the ocular lens 121. The user may measure a distance to a target located at a target aiming indicator TA by using the distance measuring apparatus 100.

The control unit 180 may display a course map image 1200 on the display unit 151b located inside the distance measuring apparatus 100. An object 1201 corresponding to a current location, an object 1203 corresponding to a target location, and a virtual line 1202 corresponding to a heading direction of the distance measuring apparatus 100 may be displayed in the course map image 1200.

Further, the control unit 180 may also additionally display indicators 1205 and 1206 indicating points of interest on the display unit 151b.

Accordingly, the user may conveniently check information about the current location, the location of the target, the heading direction of the distance measuring apparatus 100, and the point of interest through a map of a golf course displayed on the display unit 151b while checking an actual golf course through the ocular lens 121.

In the foregoing, the exemplary embodiments of the present invention have been described in detail, but the scope of the present invention is not limited thereto, and various forms changed and modified by those skilled in the art also belong to the scope of the present invention.

What is claimed is:

1. An distance measuring apparatus, the apparatus comprising:
a display unit;
a memory, in which map information about golf courses is stored;
a location acquiring sensor configured to acquire a current location;
an azimuth sensor configured to measure an azimuth; and
a control unit configured to read map information of a golf course corresponding to the current location from the memory, and display a course map image, in which an object corresponding to the current location and a virtual line corresponding to the azimuth are displayed, on the display unit by using the map information.

2. The apparatus of claim 1, wherein:
when the azimuth is changed, the control unit changes and displays the virtual line on the course map in response to the changed azimuth.

3. The apparatus of claim 2, wherein:
the control unit further displays an indicator indicating a point of interest located in a direction corresponding to the azimuth on the course map by using the current location, the azimuth, and the map information.

4. The apparatus of claim 3, wherein:
the point of interest includes at least one of a hazard, a bunker, a rough, a green, and a hole located in the golf course.

5. The apparatus of claim 3, wherein:
the control unit calculates a distance from the current location to the point of interest, and displays a distance value to the point of interest on the display unit.

6. The apparatus of claim 5, wherein:
the distance from the current location to the point of interest includes
at least one of a distance from the current location to a point, at which the point of interest starts and a distance from the current location to a point, at which the point of interest ends in a direction according to the azimuth.

7. The apparatus of claim 1, further comprising:
a distance measuring sensor configured to measure a distance to a target; and
an acceleration sensor configured to measure a tilt angle,
wherein the control unit calculates a horizontal distance value to the target by using a distance value to the target and the tilt angle, and displays the horizontal distance value on the display unit.

8. The apparatus of claim 7, wherein:
the control unit calculates location coordinates of the target by using the azimuth and the horizontal distance value and further displays an object corresponding to the location coordinates of the target on the course map.

9. The apparatus of claim 7, wherein:
the control unit further displays a virtual line extended from an object corresponding to location coordinates of the target to one point on a green in the course map in the course map by using the location coordinates of the target.

10. The apparatus of claim 9, wherein:
the control unit calculates a distance value from the target location to the one point on the green and displays a distance value to the one point on the green on the display unit.

11. A method for controlling a distance measuring apparatus, the method comprising:
acquiring, by a location acquiring sensor, a current location of a distance measuring apparatus;
reading, by a control unit, map information about a golf course corresponding to the current position from a memory, in which map information about golf courses is stored;
measuring, by an azimuth sensor, an azimuth, toward which the distance measuring apparatus heads; and
displaying, by the control unit, a course map image, in which an object corresponding to the current location and a virtual line corresponding to the azimuth are displayed, on a display unit by using the map information.

12. The method of claim 11, further comprising:
when the azimuth measured by the azimuth sensor is changed, changing and displaying, by the control unit, the virtual line on the course map in response to the changed azimuth.

13. The method of claim 12, further comprising:
displaying, by the control unit, an indicator indicating a point of interest located in a direction corresponding to the azimuth on the course map by using the current location, the azimuth, and the map information.

14. The method of claim 13, wherein:
the point of interest includes at least one of a hazard, a bunker, a rough, a green, and a hole located in the golf course.

15. The method of claim 13, wherein:
the displaying of the indicator indicating the point of interest on the course map includes:
calculating, by the control unit, a distance from the current location to the point of interest; and
displaying, by the control unit, a distance value to the point of interest on the display unit.

16. The method of claim 15, wherein:
the distance from the current location to the point of interest includes
at least one of a distance from the current location to a point, at which the point of interest starts and a distance from the current location to a point, at which the point of interest ends in a direction according to the azimuth.

17. The method of claim 11, further comprising:
measuring, by a distance measuring sensor, a distance to a target;
measuring, by an acceleration sensor, a tilt angle;
calculating, by the control unit, a horizontal distance value to the target by using a distance value to the target and the tilt angle; and
displaying, by the control unit, the horizontal distance value on the display unit.

18. The method of claim 17, further comprising;
calculating, by the control unit, location coordinates of the target by using the azimuth and the distance value; and
displaying, by the control unit, an object corresponding to the location coordinates of the target in a course map.

19. The method of claim 17, further comprising:
displaying, by the control unit, a virtual line extended from an object corresponding to location coordinates of the target to one point on a green in the course map in the course map by using the location coordinates of the target.

20. The method of claim 19, further comprising:
calculating, by the control unit, a distance from the target location to the one point on the green; and
displaying the distance on the display unit.
